(19) United States
(12) Patent Application Publication
(10) Pub. No.: US 2023/0204908 A1
(43) Pub. Date: Jun. 29, 2023

(54) OPTICAL LENS ASSEMBLY AND ELECTRONIC DEVICE

(71) Applicant: Ningbo Sunny Automotive Optech Co., Ltd., Ningbo City (CN)

(72) Inventors: Yifeng Wang, Ningbo City (CN); Dongfang Wang, Ningbo City (CN); Bo Yao, Ningbo City (CN)

(21) Appl. No.: 18/116,651

(22) Filed: Mar. 2, 2023

Related U.S. Application Data
(63) Continuation of application No. PCT/CN2021/119647, filed on Sep. 22, 2021.

(30) Foreign Application Priority Data
Sep. 22, 2020 (CN) 202011001866.6

(51) Int. Cl. G02B 9/60; G02B 13/00

(52) U.S. Cl. CPC G02B 9/60; G02B 13/0045; G02B 13/006

(57) ABSTRACT

An optical lens assembly and an electronic device comprising same. The optical lens assembly sequentially comprises, from an object side to an image side along an optical axis, a first lens (L1) having a negative refractive power, an object-side surface (S1) of the first lens being a convex surface, and an image-side surface (S2) of the first lens being a concave surface; a second lens (L2) having a positive refractive power, an object-side surface (S3) of the second lens being a convex surface, and an image-side surface (S4) of the second lens being a convex surface; a third lens (L3) having a refractive power; a fourth lens (L4) having a refractive power; and a fifth lens (L5) having a refractive power.

### CROSS-REFERENCE TO RELATED APPLICATIONS

This patent application is a continuation of International Application No. PCT/CN2021/119647, filed on Sep. 22, 2021, which claims the priority from Chinese Patent Application No. 202011001866.6, filed on Sep. 22, 2020, the entire disclosure of which are hereby incorporated by reference.

### TECHNICAL FIELD

The present disclosure relates to the field of optical element, and more specifically to an optical lens assembly and an electronic device.

### BACKGROUND

In recent years, with the rapid development of automobile auxiliary driving systems, optical lens assemblies are more and more widely used in automobiles. At the same time, users also have higher and higher requirements for the imaging quality of vehicle-mounted lens assemblies. In order to meet the application needs of vehicle-mounted front-view lens assemblies, more and more lens assembly manufacturers are beginning to investigate how to make the vehicle-mounted front-view lens assemblies have characteristics such as miniaturization and high resolution.

At present, in order to improve the resolution ability of existing vehicle-mounted optical lens assemblies, most lens assembly manufacturers usually increase the number of lenses to improve the resolution ability of the lens assemblies, but this may, to a certain extent, affect the miniaturization characteristics of the lens assemblies, also increase production costs of the lens assemblies. Therefore, how to make the vehicle-mounted optical lens assemblies have the characteristics such as high resolution, miniaturization and low cost at the same time, is one of the urgent problems that many lens assembly designers need to solve.

### SUMMARY

In a first aspect, the present disclosure provides an optical lens assembly. The optical lens assembly comprises, sequentially along an optical axis from an object side to an image side: a first lens, having a negative refractive power, an object-side surface of the first lens being a convex surface, and an image-side surface of the first lens being a concave surface; a second lens, having a positive refractive power, an object-side surface of the second lens being a convex surface, and an image-side surface of the second lens being a convex surface; a third lens, having a refractive power; a fourth lens, having a refractive power; and a fifth lens, having a refractive power.

In an embodiment, the third lens has a positive refractive power, an object-side surface of the third lens is a convex surface, and an image-side surface of the third lens is a convex surface.

In an embodiment, the third lens has a negative refractive power, an object-side surface of the third lens is a convex surface, and an image-side surface of the third lens is a concave surface.

In an embodiment, the fourth lens has a positive refractive power, an object-side surface of the fourth lens is a convex surface, and an image-side surface of the fourth lens is a convex surface.

In an embodiment, the fourth lens has a negative refractive power, an object-side surface of the fourth lens is a concave surface, and an image-side surface of the fourth lens is a concave surface.

In an embodiment, the fourth lens has a negative refractive power, an object-side surface of the fourth lens is a concave surface, and an image-side surface of the fourth lens is a convex surface.

In an embodiment, the fifth lens has a positive refractive power, an object-side surface of the fifth lens is a convex surface, and an image-side surface of the fifth lens is a convex surface.

In an embodiment, the fifth lens has a positive refractive power, an object-side surface of the fifth lens is a concave surface, and an image-side surface of the fifth lens is a convex surface.

In an embodiment, the fifth lens has a positive refractive power, an object-side surface of the fifth lens is a convex surface, and an image-side surface of the fifth lens is a concave surface.

In an embodiment, the fifth lens has a negative refractive power, an object-side surface of the fifth lens is a concave surface, and an image-side surface of the fifth lens is a convex surface.

In an embodiment, the third lens and the fourth lens are cemented to form a cemented lens.

In an embodiment, the first lens and the fifth lens both have an aspheric surface.

In an embodiment, a distance TTL from a center of the object-side surface of the first lens to an imaging plane of the optical lens assembly on the optical axis and a total effective focal length F of the optical lens assembly may satisfy: TTL/F≤8.

In an embodiment, a distance BFL from the image-side surface of the fifth lens to an imaging plane of the optical lens assembly on the optical axis and a distance TTL from a center of the object-side surface of the first lens to the imaging plane of the optical lens assembly on the optical axis may satisfy: 0.07≤BFL/TTL≤0.35.

In an embodiment, a maximal field-of-view FOV of the optical lens assembly, a maximal aperture D of the object-side surface of the first lens corresponding to the maximal field-of-view of the optical lens assembly and an image height H corresponding to the maximal field-of-view of the optical lens assembly may satisfy: D/H/FOV≤0.025.

In an embodiment, an effective focal length F1 of the first lens and a total effective focal length F of the optical lens assembly may satisfy: 0.5≤|F1/F|≤3.

In an embodiment, an effective focal length F1 of the first lens and an effective focal length F2 of the second lens may satisfy: 0.3≤|F1/F2|≤3.5.

In an embodiment, an effective focal length F3 of the third lens and an effective focal length F4 of the fourth lens may satisfy: 0.3≤F3/F4|≤3.5.

In an embodiment, a radius of curvature R1 of the object-side surface of the first lens and a radius of curvature R2 of the image-side surface of the first lens may satisfy: |R1/R2|≤5.

In an embodiment, a radius of curvature R3 of the object-side surface of the second lens and a radius of curvature R4 of the image-side surface of the second lens may satisfy: 0.5≤|R3/R4|≤5.

In an embodiment, a radius of curvature R6 of the object-side surface of the third lens and a radius of curvature R7 of the image-side surface of the third lens may satisfy: 0.5≤|R6/R7|≤5.

In an embodiment, a spacing distance T12 from a center of the image-side surface of the first lens to a center of the object-side surface of the second lens on the optical axis and a distance TTL from a center of the object-side surface of the first lens to an imaging plane of the optical lens assembly on the optical axis may satisfy: 0.1≤T12/TTL≤0.6.

In an embodiment, a spacing distance T23 from a center of the image-side surface of the second lens to a center of the object-side surface of the third lens on the optical axis and a distance TTL from a center of the object-side surface of the first lens to an imaging plane of the optical lens assembly on the optical axis may satisfy: T23/TTL≤0.25.

In an embodiment, a spacing distance T45 from a center of the image-side surface of the fourth lens to a center of the object-side surface of the fifth lens on the optical axis and a distance TTL from a center of the object-side surface of the first lens to an imaging plane of the optical lens assembly on the optical axis may satisfy: 0.008≤T45/TTL≤0.3.

In an embodiment, a maximal field-of-view FOV of the optical lens assembly, a total effective focal length F of the optical lens assembly and an image height H corresponding to the maximal field-of-view of the optical lens assembly may satisfy: (FOV×F)/H≥57°.

In an embodiment, an abbe number Vd3 of the third lens and an abbe number Vd4 of the fourth lens may satisfy: |Vd3−Vd4|≥20.

In an embodiment, an effective focal length F3 of the third lens, an effective focal length F4 of the fourth lens, an abbe number Vd3 of the third lens, an abbe number Vd4 of the fourth lens and a total effective focal length F of the optical lens assembly may satisfy: |(1/(F4×Vd4)+1/(F3×Vd3))×F|≥0.15.

In another aspect, the present disclosure provides an optical lens assembly. The optical lens assembly comprises, sequentially along an optical axis from an object side to an image side: a first lens, having a negative refractive power; a second lens, having a positive refractive power; a third lens, having a refractive power; a fourth lens, having a refractive power; and a fifth lens, having a refractive power, where a maximal field-of-view FOV of the optical lens assembly, a total effective focal length F of the optical lens assembly and an image height H corresponding to the maximal field-of-view of the optical lens assembly may satisfy: (FOV×F)/H≥57°.

In an embodiment, an object-side surface of the first lens is a convex surface, and an image-side surface of the first lens is a concave surface.

In an embodiment, an object-side surface of the second lens is a convex surface, and an image-side surface of the second lens is a convex surface.

In an embodiment, the third lens has a positive refractive power, an object-side surface of the third lens is a convex surface, and an image-side surface of the third lens is a convex surface.

In an embodiment, the third lens has a negative refractive power, an object-side surface of the third lens is a convex surface, and an image-side surface of the third lens is a concave surface.

In an embodiment, the fourth lens has a positive refractive power, an object-side surface of the fourth lens is a convex surface, and an image-side surface of the fourth lens is a convex surface.

In an embodiment, the fourth lens has a negative refractive power, an object-side surface of the fourth lens is a concave surface, and an image-side surface of the fourth lens is a concave surface.

In an embodiment, the fourth lens has a negative refractive power, an object-side surface of the fourth lens is a concave surface, and an image-side surface of the fourth lens is a convex surface.

In an embodiment, the fifth lens has a positive refractive power, an object-side surface of the fifth lens is a convex surface, and an image-side surface of the fifth lens is a convex surface.

In an embodiment, the fifth lens has a positive refractive power, an object-side surface of the fifth lens is a concave surface, and an image-side surface of the fifth lens is a convex surface.

In an embodiment, the fifth lens has a positive refractive power, an object-side surface of the fifth lens is a convex surface, and an image-side surface of the fifth lens is a concave surface.

In an embodiment, the fifth lens has a negative refractive power, an object-side surface of the fifth lens is a concave surface, and an image-side surface of the fifth lens is a convex surface.

In an embodiment, the third lens and the fourth lens are cemented to form a cemented lens.

In an embodiment, the first lens and the fifth lens both have an aspheric surface.

In an embodiment, a distance TTL from a center of the object-side surface of the first lens to an imaging plane of the optical lens assembly on the optical axis and a total effective focal length F of the optical lens assembly may satisfy: TTL/F≤8.

In an embodiment, a distance BFL from the image-side surface of the fifth lens to an imaging plane of the optical lens assembly on the optical axis and a distance TTL from a center of the object-side surface of the first lens to the imaging plane of the optical lens assembly on the optical axis may satisfy: 0.07≤BFL/TTL≤0.35.

In an embodiment, a maximal field-of-view FOV of the optical lens assembly, a maximal aperture D of the object-side surface of the first lens corresponding to the maximal field-of-view of the optical lens assembly and an image height H corresponding to the maximal field-of-view of the optical lens assembly may satisfy: D/H/FOV≤0.025.

In an embodiment, an effective focal length F1 of the first lens and a total effective focal length F of the optical lens assembly may satisfy: 0.5≤|F1/F|≤3.

In an embodiment, an effective focal length F1 of the first lens and an effective focal length F2 of the second lens may satisfy: 0.3≤|F1/F2|≤3.5.

In an embodiment, an effective focal length F3 of the third lens and an effective focal length F4 of the fourth lens may satisfy: 0.3≤F3/F4|≤3.5.

In an embodiment, a radius of curvature R1 of the object-side surface of the first lens and a radius of curvature R2 of the image-side surface of the first lens may satisfy: |R1/R2|≤5.

In an embodiment, a radius of curvature R3 of the object-side surface of the second lens and a radius of curvature R4 of the image-side surface of the second lens may satisfy: 0.5≤|R3/R4|≤5.

In an embodiment, a radius of curvature R6 of the object-side surface of the third lens and a radius of curvature R7 of the image-side surface of the third lens may satisfy: 0.5≤|R6/R7|≤5.

In an embodiment, a spacing distance T12 from a center of the image-side surface of the first lens to a center of the object-side surface of the second lens on the optical axis and a distance TTL from a center of the object-side surface of the first lens to an imaging plane of the optical lens assembly on the optical axis may satisfy: 0.1≤T12/TTL≤0.6.

In an embodiment, a spacing distance T23 from a center of the image-side surface of the second lens to a center of the object-side surface of the third lens on the optical axis and a distance TTL from a center of the object-side surface of the first lens to an imaging plane of the optical lens assembly on the optical axis may satisfy: T23/TTL≤0.25.

In an embodiment, a spacing distance T45 from a center of the image-side surface of the fourth lens to a center of the object-side surface of the fifth lens on the optical axis and a distance TTL from a center of the object-side surface of the first lens to an imaging plane of the optical lens assembly on the optical axis may satisfy: 0.008≤T45/TTL≤0.3.

In an embodiment, an abbe number Vd3 of the third lens and an abbe number Vd4 of the fourth lens may satisfy: |Vd3−Vd4|≥20.

In an embodiment, an effective focal length F3 of the third lens, an effective focal length F4 of the fourth lens, an abbe number Vd3 of the third lens, an abbe number Vd4 of the fourth lens and a total effective focal length F of the optical lens assembly may satisfy: |(1/(F4×Vd4)+1/(F3×Vd3))×F|≤0.15.

In another aspect, the present disclosure provides an electronic device. The electronic device includes the optical lens assembly provided by the present disclosure and an imaging element used to convert an optical image formed by the optical lens assembly into an electrical signal.

The present disclosure uses five lenses. By optimizing the shapes and refractive powers of the lenses, the optical lens assembly has at least one beneficial effect such as high resolution, miniaturization, a low cost, a small front-end diameter, a small CRA, a large aperture, or large resolution of a center angle.

### BRIEF DESCRIPTION OF THE DRAWINGS

In combination with the accompanying drawings, other features, objectives and advantages of the present disclosure will become more apparent through the following detailed description for non-limiting embodiments. In the accompanying drawings:

FIG. 1 is a schematic structural diagram of an optical lens assembly according to Embodiment 1 of the present disclosure;

FIG. 2 is a schematic structural diagram of an optical lens assembly according to Embodiment 2 of the present disclosure;

FIG. 3 is a schematic structural diagram of an optical lens assembly according to Embodiment 3 of the present disclosure;

FIG. 4 is a schematic structural diagram of an optical lens assembly according to Embodiment 4 of the present disclosure;

FIG. 5 is a schematic structural diagram of an optical lens assembly according to Embodiment 5 of the present disclosure;

FIG. 6 is a schematic structural diagram of an optical lens assembly according to Embodiment 6 of the present disclosure; and

FIG. 7 is a schematic structural diagram of an optical lens assembly according to Embodiment 7 of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, the first lens discussed below may also be referred to as the second lens or the third lens without departing from the teachings of the present disclosure.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. A surface of each lens that is closest to a photographed object is referred to as the object-side surface of the lens, and a surface of the each lens that is closest to an image side is referred to as the image-side surface of the lens.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, expressions such as “at least one of,” when preceding a list of listed features, modify the entire list of features rather than an individual element in the list. Further, the use of “may,” when describing the implementations of the present disclosure, relates to “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. The present disclosure will be described below in detail with reference to the accompanying drawings and in combination with the embodiments.

Features, principles and other aspects of the present disclosure are described below in detail.

In exemplary implementations, an optical lens assembly includes, for example, five lenses (i.e., a first lens, a second lens, a third lens, a fourth lens, and a fifth lens) having refractive powers. The five lenses are arranged in sequence along an optical axis from an object side to an image side.

In the exemplary implementations, the optical lens assembly may further include a photosensitive element disposed on an imaging plane. Alternatively, the photosensitive element disposed on the imaging plane may be a charge coupled device (CCD) or complementary metal-oxide semiconductor element (CMOS).

In the exemplary implementations, the first lens may have a negative refractive power. The first lens may have a convex-concave shape. The first lens has a negative refractive power, which can not only improve an imaging quality of the optical lens assembly, but also can avoid excessive divergence of the light from the object side, so as to facilitate the control of the diameter of a rear lens. An object-side surface of the first lens is a convex surface, so light in a large field-of-view may be collected as much as possible to enter a rear optical system, increasing the amount of light passing, and helping achieve an overall large field-of-view. At the same time, the object-side surface of the first lens being a convex surface is conducive to adapting the lens assembly to an outdoor use environment, such as the sliding of water droplets onto the lens assembly in bad weathers such as rainy and snowy weather, which may reduce the impact on lens assembly imaging.

In the exemplary implementations, the second lens may have a positive refractive power. The second lens may have a dual-convex shape. The setting for the refractive power and the surface shape of the second lens may further converge and adjust the light and correct chromatic aberrations.

In the exemplary implementations, the third lens may have a positive refractive power or a negative refractive power. The third lens may have a dual-convex shape or a convex-concave shape.

In the exemplary implementations, the fourth lens may have a positive refractive power or a negative refractive power. The fourth lens may have a dual-convex shape, a biconcave shape or a concave-convex shape.

In the exemplary implementations, the fifth lens may have a positive refractive power or a negative refractive power. The fifth lens may have a dual-convex shape, a concave-convex shape or a convex-concave shape. The setting for the refractive power and the surface shape of the fifth lens is conducive to adjusting the light, correcting chromatic aberrations, correcting aberrations such as field curvature, astigmatism, and at the same time may make the light trend stable, which is conducive to imaging on the imaging plane.

In the exemplary implementations, the first lens and the fifth lens may both have an aspheric surface, to improve resolution.

In the exemplary implementations, the optical lens assembly according to the present disclosure may satisfy: TTL/F≤8. Here, TTL is a distance from a center of the object-side surface of the first lens to an imaging plane of the optical lens assembly on the optical axis, and F is a total effective focal length of the optical lens assembly. More specifically, TTL and F may further satisfy: TTL/F≤7. Satisfying TTL/F≤8 is conducive to implementing miniaturization.

In the exemplary implementations, the optical lens assembly according to the present disclosure may satisfy: 0.07≤BFL/TTL≤0.35. Here, BFL is a distance from the image-side surface of the fifth lens to the imaging plane of the optical lens assembly on the optical axis, and TTL is the distance from the center of the object-side surface of the first lens to the imaging plane of the optical lens assembly on the optical axis. More specifically, BFL and TTL may further satisfy: 0.1≤BFL/TTL≤0.25. Satisfying BFL/TTL≥0.07, on the basis of achieving miniaturization, a back focus BFL of the optical lens assembly can be longer, which is conducive to reducing CPA, and conducive to the assembly of a module. Satisfying BFL/TTL≤0.35, a total track length TTL of the optical lens assembly can be shorter and compact, which is conducive to reducing the sensitivity of the lenses to MTF, improving a production yield and reducing a production cost.

In the exemplary implementations, the optical lens assembly according to the present disclosure may satisfy: D/H/FOV≤0.025. Here, FOV is a maximal field-of-view of the optical lens assembly, D is a maximal aperture of the object-side surface of the first lens corresponding to the maximal field-of-view of the optical lens assembly, and H is an image height corresponding to the maximal field-of-view of the optical lens assembly. More specifically, D, H and FOV may further satisfy: D/H/FOV≤0.02. Satisfying D/H/FOV≤0.025 facilitates making a front-end diameter of the optical lens assembly smaller.

In the exemplary implementations, the optical lens assembly according to the present disclosure may satisfy: 0.5≤|F1/F|≤3. Here, F1 is an effective focal length of the first lens, and F is the total effective focal length of the optical lens assembly. More specifically, F1 and F may further satisfy: 0.8≤|F1/F|≤2.5. Satisfying 0.5≤|F1/F|≤3 is conducive to increasing the resolution of a center angle of the optical lens assembly and increasing a relative illumination.

In the exemplary implementations, the optical lens assembly according to the present disclosure may satisfy: 0.3≤|F1/F2|≤3.5. Here, F1 is the effective focal length of the first lens, and F2 is an effective focal length of the second lens. More specifically, F1 and F2 may further satisfy: 0.45≤|F1/F2|≤2.5. Satisfying 0.3≤|F1/F2|≤3.5 is conducive to the smooth transition of the light and improving the imaging quality.

In the exemplary implementations, the optical lens assembly according to the present disclosure may satisfy: 0.3≤|F3/F4|≤3.5. Here, F3 is an effective focal length of the third lens, and F4 is an effective focal length of the fourth lens. More specifically, F3 and F4 may further satisfy: 0.45≤|F3/F4|≤3. Satisfying 0.3≤F3/F4|≤3.5 is conducive to the smooth transition of the light and correcting chromatic aberrations.

In the exemplary implementations, the optical lens assembly according to the present disclosure may satisfy: |R1/R2|≤5. Here, R1 is a radius of curvature of the object-side surface of the first lens, and R2 is a radius of curvature of the image-side surface of the first lens. More specifically, R1 and R2 may further satisfy: |R1/R2|≤4.2. Satisfying |R1/R2|≤5 is conducive to smooth entry of the light into the optical lens assembly and improving resolution quality.

In the exemplary implementations, the optical lens assembly according to the present disclosure may satisfy: 0.5≤|R3/R4|≤5. Here, R3 is a radius of curvature of the object-side surface of the second lens, and R4 is a radius of curvature of the image-side surface of the second lens. More specifically, R3 and R4 may further satisfy: 0.8≤|R3/R4|≤4.2. Satisfying 0.5≤R3/R4|≤5 may reduce aberrations of the optical lens assembly, and facilitate the smooth transition of the light passing through the first lens to the rear optical system, thereby reducing a tolerance sensitivity of the optical lens assembly.

In the exemplary implementations, the optical lens assembly according to the present disclosure may satisfy: 0.5≤|R6/R7|≤5. Here, R6 is a radius of curvature of the object-side surface of the third lens, and R7 is a radius of curvature R7 of the image-side surface of the third lens. More specifically, R6 and R7 may further satisfy: 0.8≤|R6/R7|≤4.2. Satisfying 0.5≤R6/R7|≤5 may reduce aberrations of the optical lens assembly, and facilitate the smooth transition of the light passing through the second lens to the rear optical system, thereby reducing the tolerance sensitivity of the optical lens assembly.

In the exemplary implementations, the optical lens assembly according to the present disclosure may satisfy: 0.1≤T12/TTL≤0.6. Here, T12 is a spacing distance from a center of the image-side surface of the first lens to a center of the object-side surface of the second lens on the optical axis, and TTL is the distance from the center of the object-side surface of the first lens to the imaging plane of the optical lens assembly on the optical axis. More specifically, T12 and TTL may further satisfy: 0.13≤T12/TTL≤0.4. Satisfying 0.1≤T12/TTL≤0.6 may effectively reduce the CRA of the optical lens assembly and facilitate miniaturization.

In the exemplary implementations, the optical lens assembly according to the present disclosure may satisfy: T23/TTL≤0.25. Here, T23 is a spacing distance from a center of the image-side surface of the second lens to a center of the object-side surface of the third lens on the optical axis, and TTL is the distance from the center of the object-side surface of the first lens to the imaging plane of the optical lens assembly on the optical axis. More specifically, T23 and TTL may further satisfy: T23/TTL≤0.18. Satisfying T23/TTL≤0.25 is conducive to reducing the diameter of the lens, and reducing a total volume of the optical lens assembly, which may improve the resolution quality of the optical lens assembly and an overall brightness of the screen, while achieving characteristics such as miniaturization and low cost.

In the exemplary implementations, the optical lens assembly according to the present disclosure may satisfy: 0.008≤T45/TTL≤0.3. Here, T45 is a spacing distance from a center of the image-side surface of the fourth lens to a center of the object-side surface of the fifth lens on the optical axis, and TTL is the distance from the center of the object-side surface of the first lens to the imaging plane of the optical lens assembly on the optical axis. More specifically, T45 and TTL may further satisfy: 0.01≤T45/TTL≤0.2. Satisfying 0.008≤T45/TTL≤0.3 may make the light converge smoothly to reduce the sensitivity of the optical lens assembly.

In the exemplary implementations, the optical lens assembly according to the present disclosure may satisfy: (FOV×F)/H≥57°. Here, FOV is the maximal field-of-view of the optical lens assembly, F is the total effective focal length of the optical lens assembly, and H is the image height corresponding to the maximal field-of-view of the optical lens assembly. More specifically, FOV, F and H may further satisfy: (FOV×F)/H≥62°. Satisfying (FOV×F)/H≥57° is conducive to achieving characteristics such as large distortion, long focal length, and large field-of-view within a reasonable range.

In the exemplary implementations, the optical lens assembly according to the present disclosure may satisfy: |Vd3−Vd4|≥20. Here, Vd3 is an abbe number of the third lens, and Vd4 is an abbe number of the fourth lens. More specifically, Vd3 and Vd4 may further satisfy: |Vd3−Vd4|≥28. Satisfying |Vd3−Vd4|≥20 is conducive to correcting chromatic aberrations, and making a difference between the refractive powers of the third lens and the fourth lens smaller.

In the exemplary implementations, the optical lens assembly according to the present disclosure may satisfy: |(1/(F4×Vd4)+1/(F3×Vd3))×F|≤0.15. Here, F3 is the effective focal length of the third lens, F4 is the effective focal length of the fourth lens, Vd3 is the abbe number of the third lens, Vd4 is the abbe number of the fourth lens, and F is the total effective focal length of the optical lens assembly. More specifically, F4, Vd4, F3 and Vd3 may further satisfy: |(1/(F4×Vd4)+1/(F3×Vd3))×F|≤0.1. Satisfying |(1/(F4×Vd4)+1/(F3×Vd3))×F|≤0.15 is conducive to correcting chromatic aberrations and improving the resolution.

In the exemplary implementations, the optical lens assembly according to the present disclosure may satisfy: F2/F≤30. Here, F2 is the effective focal length of the second lens, and F is the total effective focal length of the optical lens assembly. More specifically, F2 and F may further satisfy: F2/F≤18. For example, F2 and F may further satisfy: F2/F≤4.5.

In the exemplary implementations, the optical lens assembly according to the present disclosure may satisfy: −25≤F3/F≤25. Here, F3 is the effective focal length of the third lens, and F is the total effective focal length of the optical lens assembly. More specifically, F3 and F may further satisfy: −15≤F3/F≤15. For example, F3 and F may further satisfy: −4.5≤F3/F≤3.5.

In the exemplary implementations, the optical lens assembly according to the present disclosure may satisfy: −25≤F4/F≤25. Here, F4 is the effective focal length of the fourth lens, and F is the total effective focal length of the optical lens assembly. More specifically, F4 and F may further satisfy: −15≤F4/F≤15. For example, F4 and F may further satisfy: −4≤F4/F≤3.5.

In the exemplary implementations, the optical lens assembly according to the present disclosure may satisfy: −100≤F5/F≤100. Here, F5 is an effective focal length of the fifth lens, and F is the total effective focal length of the optical lens assembly. More specifically, F5 and F may further satisfy: −45% F5/F≤45. For example, F5 and F may further satisfy: −25≤F5/F≤25.

In the exemplary implementations, a diaphragm used to restrict light beams may be disposed between the second lens and the third lens to further improve the imaging quality of the optical lens assembly. Disposing the diaphragm between the second lens and the third lens is conducive to increasing the diameter of the diaphragm, and effectively converging the light entering the optical lens assembly, to reduce the diameter of the lens and shorten the total length of the optical lens assembly. In the implementations of the present disclosure, the diaphragm may be disposed near the image-side surface of the second lens, or near the object-side surface of the third lens. However, it should be noted that the positions of the diaphragm disclosed here are only examples, rather than limitations. In alternative implementations, the diaphragm may be disposed at other positions according to actual needs.

In the exemplary implementations, the optical lens assembly according to the present disclosure may further include an optical filter/protective glass disposed between the fifth lens and the imaging plane, to filter light with different wavelengths, and prevent elements (e.g., chips) on the image side of the optical lens assembly from being damaged.

As known to those skilled in the art, the cemented lens may be used to reduce or eliminate chromatic aberrations to the greatest extent. The use of the cemented lens in the optical lens assembly can improve the imaging quality and reduce the reflection loss of light energy, thereby achieving high resolution and improving the image clarity of lens assembly. In addition, the use of the cemented lens may simplify the assembling procedures in the process of manufacturing the lens assembly.

In the exemplary implementations, the third lens and the fourth lens may be cemented to form a cemented lens. The third lens and the fourth lens have opposite refractive powers. For example, if the third lens has a negative refractive power, then the fourth lens has a positive refractive power. The third lens having a convex object-side surface and a convex image-side surface and the fourth lens having a concave object-side surface and a concave image-side surface or a convex image-side surface are cemented, or the third lens having a convex object-side surface and a concave image-side surface and the fourth lens having a convex object-side surface and a convex image-side surface are cemented, which is conducive to the smooth transition of the light passing through the third lens to the rear optical system, and reducing the total length of the optical lens assembly. Of course, the third lens and the fourth lens may also not be cemented, which is conducive to improving the resolution.

The cementing approach between the above lenses has at least one of the following advantages: reducing the chromatic aberrations of the lenses, reducing the tolerance sensitivity, and balancing the overall chromatic aberration of the system through residual chromatic aberrations; reducing the spacing distance between the two lenses, thereby reducing the total length of the system; reducing the assembly part between lenses, thereby reducing procedures and costs; reducing the tolerance sensitivity problem of a lens unit caused by the tilt/eccentricity in the assembling process, thereby improve the production yield; reducing the loss in the amount of light caused by the reflection between lenses, thereby improving illumination; and further reducing the field curvature, thereby effectively correcting the off-axis point aberration of the optical lens assembly. Such cementing design shares the overall chromatic aberration correction of the system, the aberrations are effectively corrected to improve the resolution. The cementing design makes the optical system compact as a whole, thereby meeting the miniaturization requirement.

In the exemplary implementations, the second lens, the third lens and the fourth lens may be spherical lenses. The first lens and the fifth lens may be aspheric lenses. In particular, the first lens, the second lens, the third lens, the fourth lens and the fifth lens may all be aspheric lenses in order to improve the resolution quality of the optical system. The aspheric lens is characterized in that the curvature continuously changes from the center of the lens to the periphery of the lens. Different from a spherical lens having a constant curvature from the center of the lens to the periphery of the lens, the aspheric lens has a better radius-of-curvature characteristic, and has advantages of improving the distortion aberration and improving the astigmatic aberration. The use of the aspheric lens can eliminate as much as possible the aberrations that occur during the imaging, thereby improving the imaging quality. The setting of the aspheric lens helps to correct the aberrations of the system and improve the resolution.

Through the reasonable settings for the shapes and refractive powers of the lenses, in the situation where only five lenses are used, the optical lens assembly according to the above implementations of the present disclosure enables the optical system to achieve at least one beneficial effect such as high resolution (which can be up to 2 million pixels or more), low cost, miniaturization, large center angle resolution, long back focus and good imaging quality. At the same time, the optical system also takes into account the requirements for a small lens assembly size, a small front-end diameter, a low sensitivity and a high production yield. The optical lens assembly also has a small CRA, which prevents generation of stray light from hitting a lens barrel when the rear end of the light exits, and may be well matched with, for example, on-board chips, without color cast and vignetting. At the same time, the optical lens assembly has a large aperture, good imaging effect, can make the imaging quality to high-definition level, even in the night or low light environment, can also have a clear imaging picture.

The optical lens assembly according to the above implementations of the present disclosure is provided with the cemented lens to share the overall chromatic aberration correction of the system, which is not only conducive to correcting the aberration of the system, improving the resolution quality of the system and reducing the problem of matching sensitivity, but also conducive to making the overall structure of the optical system compact and meeting the miniaturization requirement.

In the exemplary implementations, the first to fifth lenses in the optical lens assembly may all be made of glass. The optical lens assembly made of glass can suppress the deviation of the back focus of the optical lens assembly caused by a temperature change, to improve the stability of the system. At the same time, the use of the glass material can avoid the influence on the normal use of the lens assembly due to the blurred image of the lens assembly caused by the change of the high and low temperatures in the use environment. Specifically, when the resolution quality and the reliability are the focus, the first to fifth lenses may all be glass aspherical lenses. Of course, in application scenarios where there are low requirements for the temperature stability, the first to fifth lenses in the optical lens assembly can alternatively all be made of plastic. Using the plastic to make the optical lens assembly can effectively reduce the production cost.

However, it should be understood by those skilled in the art that the various results and advantages described in the present specification may be obtained by changing the number of the lenses constituting the lens assembly without departing from the technical solution claimed by the present disclosure. For example, although the optical lens assembly having five lenses is described as an example in the implementations, the optical lens assembly is not limited to including the five lenses. If desired, the optical lens assembly may also include other numbers of lenses.

Specific embodiments of the optical lens assembly that may be applicable to the above implementations are further described below with reference to the accompanying drawings.

### Embodiment 1

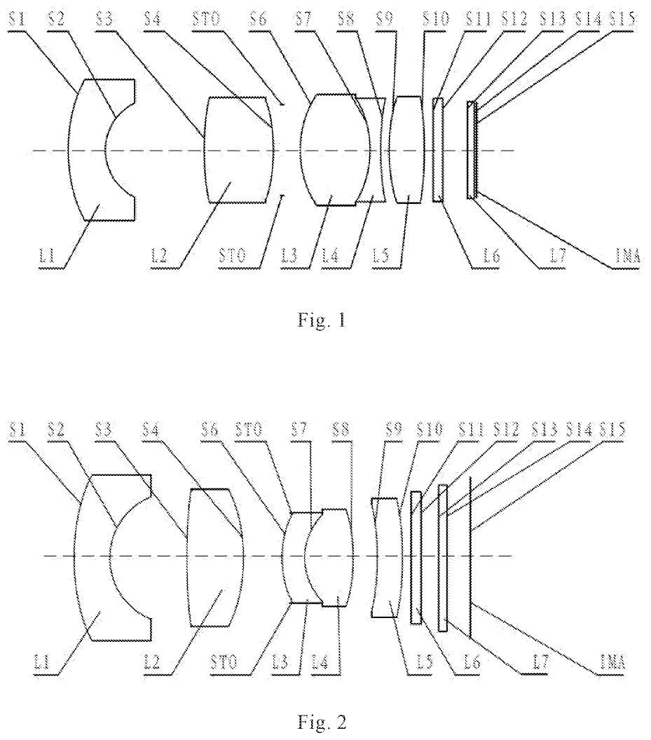

An optical lens assembly according to Embodiment 1 of the present disclosure is described below with reference to FIG. 1. FIG. 1 is a schematic structural diagram of the optical lens assembly according to Embodiment 1 of the present disclosure.

As shown in FIG. 1, the optical lens assembly includes, sequentially along an optical axis from an object side to an image side, a first lens L1, a second lens L2, a third lens L3, a fourth lens L4, and a fifth lens L5.

The first lens L1 is a convex-concave lens having a negative refractive power, an object-side surface S1 of the first lens L1 is a convex surface, and an image-side surface S2 of the first lens L1 is a concave surface. The second lens L2 is a dual-convex lens having a positive refractive power, an object-side surface S3 of the second lens L2 is a convex surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-concave lens having a negative refractive power, an object-side surface S7 of the fourth lens L4 is a concave surface, and an image-side surface S8 of the fourth lens L4 is a concave surface. The fifth lens L5 is a dual-convex lens having a positive refractive power, an object-side surface S9 of the fifth lens L5 is a convex surface, and an image-side surface S10 of the fifth lens L5 is a convex surface. The third lens L3 and the fourth lens L4 may be cemented to form a cemented lens. The optical lens assembly may further include a diaphragm STO, and the diaphragm STO may be disposed between the second lens L2 and the third lens L3 to improve the imaging quality. For example, the diaphragm STO may be disposed at a position between the second lens L2 and the third lens L3 near the image-side surface S4 of the second lens L2.

Alternatively, the optical lens assembly may further include an optical filter L6 having an object-side surface S11 and an image-side surface S12. The optical filter L6 may be used to correct color deviations. The optical lens assembly may further include a protective glass L7 having an object-side surface S13 and an image-side surface S14. The protective glass L7 may be used to protect an image sensing chip IMA at an imaging plane S15. Light from an object sequentially passes through the surfaces S1-S14 and finally forms an image on the imaging plane S15.

Table 1 shows a radius of curvature R, a thickness d/distance T (it should be understood that the thickness d/distance T in the row of S1 refers to the center thickness dl of the first lens L1, and the thickness d/distance T in the row of S2 refers to a spacing distance T12 between the first lens L1 and the second lens L2, and so on), a refractive index Nd and an abbe number Vd of each lens of the optical lens assembly in Embodiment 1.

TABLE 1

| | radius of | thickness | | |
|---|---|---|---|---|
| surface | curvature R | d/distance T | refractive | abbe |
| number | (mm) | (mm) | index Nd | number Vd |
| S1 | 3.9704 | 2.0909 | 1.81 | 41.0 |
| S2 | 1.9511 | 5.5775 | | |
| S3 | 15.1406 | 3.8943 | 1.69 | 54.9 |
| S4 | −9.2958 | 0.4854 | | |
| STO | infinite | 1.0273 | | |
| S6 | 5.6545 | 3.9330 | 1.62 | 63.4 |
| S7 | −5.6545 | 0.6000 | 1.85 | 23.8 |
| S8 | 15.5060 | 0.4785 | | |
| S9 | 7.5921 | 1.9823 | 1.59 | 61.2 |
| S10 | −205.1992 | 0.5000 | | |
| S11 | infinite | 0.5500 | 1.52 | 64.2 |
| S12 | infinite | 1.3731 | | |
| S13 | infinite | 0.4000 | 1.52 | 64.2 |
| S14 | infinite | 0.1250 | | |
| S15 | infinite | / | | |

In Embodiment 1, the first lens L1 and the fifth lens L5 may all be aspheric surfaces, and the second lens L2, the third lens L3 and the fourth lens L4 may be spherical lenses. The surface type x of each aspheric lens may be defined using, but not limited to, the following aspheric formula:

$$x = \frac{c {h}^{2}}{1 + \sqrt{1 - ( k + 1 ) {c}^{2} {h}^{2}}} + \sum {Aih}^{i} . \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface. Table 2 below gives the conic coefficients k and the high-order coefficients A4, A6, A8, A10, A12, A14 and A16 applicable to the aspheric surfaces S1, S2, S9 and S10 in Embodiment 1.

TABLE 2

| surface | | | | | | | | |
|---|---|---|---|---|---|---|---|---|
| number | k | A4 | A6 | A8 | A10 | A12 | A14 | A16 |
| S1 | −0.3877 | −3.0551E−03 | −4.5557E−04 | 2.3291E−05 | −3.4184E−07 | −4.1280E−09 | −4.3085E−12 | 2.4966E−13 |
| S2 | −0.6834 | −7.9443E−03 | −1.5368E−03 | 2.6300E−04 | −1.7633E−05 | 4.6941E−07 | 1.6601E−10 | 4.2927E−11 |
| S9 | −15.0590 | 8.2274E−04 | 8.7355E−05 | −6.2683E−05 | 7.3693E−06 | −2.4718E−07 | / | / |
| S10 | 145.7151 | −6.6957E−03 | 1.0964E−03 | −1.4621E−04 | 1.1755E−05 | −3.7782E−07 | / | / |

### Embodiment 2

An optical lens assembly according to Embodiment 2 of the present disclosure is described below with reference to FIG. 2. In this and the following embodiments, descriptions similar in part to Embodiment 1 will be omitted for the sake of brevity. FIG. 2 is a schematic structural diagram of the optical lens assembly according to Embodiment 2 of the present disclosure.

As shown in FIG. 2, the optical lens assembly includes, sequentially along an optical axis from an object side to an image side, a first lens L1, a second lens L2, a third lens L3, a fourth lens L4, and a fifth lens L5.

The first lens L1 is a convex-concave lens having a negative refractive power, an object-side surface S1 of the first lens L1 is a convex surface, and an image-side surface S2 of the first lens L1 is a concave surface. The second lens L2 is a dual-convex lens having a positive refractive power, an object-side surface S3 of the second lens L2 is a convex surface, and an image-side surface S4 of the second lens L2 is a convex surface. The third lens L3 is a convex-concave lens having a negative refractive power, an object-side surface S5 of the third lens L3 is a convex surface, and an image-side surface S6 of the third lens L3 is a concave surface. The fourth lens L4 is a dual-convex lens having a positive refractive power, an object-side surface S7 of the fourth lens L4 is a convex surface, and an image-side surface S8 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The third lens L3 and the fourth lens L4 may be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position between the second lens L2 and the third lens L3 near the image-side surface S6 of the third lens L3.

Alternatively, the optical lens assembly may further include an optical filter L6 having an object-side surface S11 and an image-side surface 512. The optical filter L6 may be used to correct color deviations. The optical lens assembly may further include a protective glass L7 having an object-side surface S13 and an image-side surface 514. The protective glass L7 may be used to protect an image sensing chip IMA at an imaging plane 515. Light from an object sequentially passes through the surfaces S1-S14 and finally forms an image on the imaging plane S15.

Table 3 shows a radius of curvature R, a thickness d/distance T, a refractive index Nd and an abbe number Vd of each lens of the optical lens assembly in Embodiment 2. Table 4 shows the conic coefficients and the high-order coefficients applicable to the aspheric surfaces in Embodiment 2. Here, the surface type of each aspheric surface may be defined using the formula (1) given in Embodiment 1.

TABLE 3

| | radius of | thickness | | |
|---|---|---|---|---|
| surface | curvature R | d/distance T | refractive | abbe |
| number | (mm) | (mm) | index Nd | number Vd |
| S1 | 4.0685 | 2.0487 | 1.81 | 41.0 |
| S2 | 1.9656 | 4.4158 | | |
| S3 | 31.0247 | 3.2453 | 1.80 | 46.6 |
| S4 | −9.4012 | 2.7605 | | |
| STO | infinite | −0.5491 | | |
| S6 | 5.5987 | 1.2970 | 1.92 | 18.9 |
| S7 | 3.5202 | 2.7862 | 1.50 | 81.6 |
| S8 | −9.2402 | 1.3807 | | |
| S9 | −49.0608 | 1.4464 | 1.59 | 61.2 |
| S10 | −200.0000 | 0.5000 | | |
| S11 | infinite | 0.5500 | 1.52 | 64.2 |
| S12 | infinite | 1.0000 | | |
| S13 | infinite | 0.5000 | 1.52 | 64.2 |
| S14 | infinite | 1.3315 | | |
| S15 | infinite | / | | |

TABLE 4

| surface | | | | | | | | |
|---|---|---|---|---|---|---|---|---|
| number | k | A4 | A6 | A8 | A10 | A12 | A14 | A16 |
| S1 | −0.6199 | −2.4682E−03 | −2.5653E−04 | 5.2010E−06 | 6.3911E−07 | −3.9781E−08 | 8.5523E−10 | −6.2023E−12 |
| S2 | −1.0410 | −1.8036E−03 | −1.2972E−03 | 1.7813E−04 | −1.0777E−05 | 3.2665E−07 | −4.1331E−09 | 3.1700E−11 |
| S9 | −90.0671 | −3.7217E−03 | −3.6313E−04 | 3.0132E−04 | −7.8454E−05 | 9.8741E−06 | −5.7332E−07 | 1.1541E−08 |
| S10 | −89.9933 | −3.7993E−03 | −4.0058E−04 | 2.4716E−04 | −5.2179E−05 | 5.5096E−06 | −2.8251E−07 | 5.6958E−09 |

### Embodiment 3

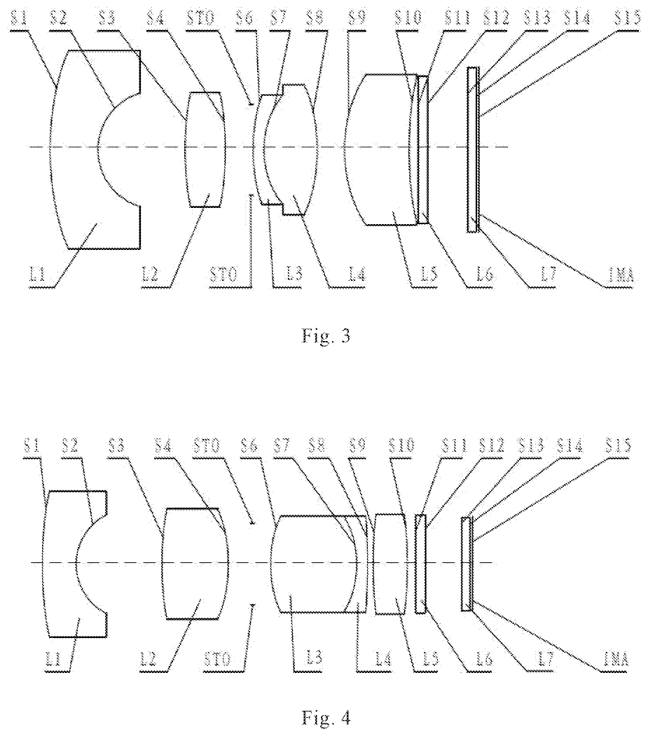

An optical lens assembly according to Embodiment 3 of the present disclosure is described below with reference to FIG. 3. FIG. 3 is a schematic structural diagram of the optical lens assembly according to Embodiment 3 of the present disclosure.

As shown in FIG. 3, the optical lens assembly includes, sequentially along an optical axis from an object side to an image side, a first lens L1, a second lens L2, a third lens L3, a fourth lens L4, and a fifth lens L5.

The first lens L1 is a convex-concave lens having a negative refractive power, an object-side surface S1 of the first lens L1 is a convex surface, and an image-side surface S2 of the first lens L1 is a concave surface. The second lens L2 is a dual-convex lens having a positive refractive power, an object-side surface S3 of the second lens L2 is a convex surface, and an image-side surface S4 of the second lens L2 is a convex surface. The third lens L3 is a convex-concave lens having a negative refractive power, an object-side surface S5 of the third lens L3 is a convex surface, and an image-side surface S6 of the third lens L3 is a concave surface. The fourth lens L4 is a dual-convex lens having a positive refractive power, an object-side surface S7 of the fourth lens L4 is a convex surface, and an image-side surface S8 of the fourth lens L4 is a convex surface. The fifth lens L5 is a convex-concave lens having a positive refractive power, an object-side surface S9 of the fifth lens L5 is a convex surface, and an image-side surface S10 of the fifth lens L5 is a concave surface. The third lens L3 and the fourth lens L4 may be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position between the second lens L2 and the third lens L3 near the image-side surface S6 of the third lens L3.

Alternatively, the optical lens assembly may further include an optical filter L6 having an object-side surface S11 and an image-side surface S12. The optical filter L6 may be used to correct color deviations. The optical lens assembly may further include a protective glass L7 having an object-side surface S13 and an image-side surface S14. The protective glass L7 may be used to protect an image sensing chip IMA at an imaging plane S15. Light from an object sequentially passes through the surfaces S1-S14 and finally forms an image on the imaging plane S15.

Table 5 shows a radius of curvature R, a thickness d/distance T, a refractive index Nd and an abbe number Vd of each lens of the optical lens assembly in Embodiment 3. Table 6 shows the conic coefficients and the high-order coefficients applicable to the aspheric surfaces in Embodiment 3. Here, the surface type of each aspheric surface may be defined using the formula (1) given in Embodiment 1.

TABLE 5

| | radius of | thickness | | |
|---|---|---|---|---|
| surface | curvature R | d/distance T | refractive | abbe |
| number | (mm) | (mm) | index Nd | number Vd |
| S1 | 4.4760 | 2.6769 | 1.59 | 61.2 |
| S2 | 1.9478 | 4.8859 | | |
| S3 | 16.8015 | 2.2433 | 1.90 | 31.3 |
| S4 | −16.8015 | 1.4435 | | |
| STO | infinite | 0.1261 | | |
| S6 | 9.8403 | 0.6000 | 1.92 | 18.9 |
| S7 | 4.9549 | 2.9854 | 1.50 | 81.6 |
| S8 | −9.3483 | 1.5311 | | |
| S9 | 8.7808 | 3.6146 | 1.59 | 61.2 |
| S10 | 22.3048 | 0.5000 | | |
| S11 | infinite | 0.5500 | 1.52 | 64.2 |
| S12 | infinite | 2.2277 | | |
| S13 | infinite | 0.5000 | 1.52 | 64.2 |
| S14 | infinite | 0.1250 | | |
| S15 | infinite | / | | |

TABLE 6

| surface | | | | | | |
|---|---|---|---|---|---|---|
| number | k | A4 | A6 | A8 | A10 | A12 |
| S1 | −0.3968 | −2.1343E−03 | −2.4094E−04 | 9.9424E−06 | −1.3895E−07 | −5.0794E−10 |
| S2 | −0.7960 | −3.5250E−03 | −1.2907E−03 | 1.5730E−04 | −8.2965E−06 | 1.7182E−07 |
| S9 | 2.3135 | −6.6290E−04 | 6.5644E−05 | −6.2659E−06 | 2.8070E−07 | −5.8994E−09 |
| S10 | −8.1086 | −7.8655E−04 | 1.0864E−04 | −3.6633E−06 | −1.0762E−07 | 1.0728E−08 |

### Embodiment 4

An optical lens assembly according to Embodiment 4 of the present disclosure is described below with reference to FIG. 4. FIG. 4 is a schematic structural diagram of the optical lens assembly according to Embodiment 4 of the present disclosure.

As shown in FIG. 4, the optical lens assembly includes, sequentially along an optical axis from an object side to an image side, a first lens L1, a second lens L2, a third lens L3, a fourth lens L4, and a fifth lens L5.

The first lens L1 is a convex-concave lens having a negative refractive power, an object-side surface S1 of the first lens L1 is a convex surface, and an image-side surface S2 of the first lens L1 is a concave surface. The second lens L2 is a dual-convex lens having a positive refractive power, an object-side surface S3 of the second lens L2 is a convex surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a concave-convex lens having a negative refractive power, an object-side surface S7 of the fourth lens L4 is a concave surface, and an image-side surface S8 of the fourth lens L4 is a convex surface. The fifth lens L5 is a dual-convex lens having a positive refractive power, an object-side surface S9 of the fifth lens L5 is a convex surface, and an image-side surface S10 of the fifth lens L5 is a convex surface. The third lens L3 and the fourth lens L4 may be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position between the second lens L2 and the third lens L3 near the image-side surface S6 of the third lens L3.

Alternatively, the optical lens assembly may further include an optical filter L6 having an object-side surface S11 and an image-side surface S12. The optical filter L6 may be used to correct color deviations. The optical lens assembly may further include a protective glass L7 having an object-side surface S13 and an image-side surface 514. The protective glass L7 may be used to protect an image sensing chip IMA at an imaging plane S15. Light from an object sequentially passes through the surfaces S1-S14 and finally forms an image on the imaging plane S15.

Table 7 shows a radius of curvature R, a thickness d/distance T, a refractive index Nd and an abbe number Vd of each lens of the optical lens assembly in Embodiment 4. Table 8 shows the conic coefficients and the high-order coefficients applicable to the aspheric surfaces in Embodiment 4. Here, the surface type of each aspheric surface may be defined using the formula (1) given in Embodiment 1.

TABLE 7

| | radius of | thickness | | |
|---|---|---|---|---|
| surface | curvature R | d/distance T | refractive | abbe |
| number | (mm) | (mm) | index Nd | number Vd |
| S1 | 6.3455 | 1.9647 | 1.81 | 41.0 |
| S2 | 2.0304 | 4.9949 | | |
| S3 | 18.1809 | 3.8511 | 1.76 | 52.3 |
| S4 | −8.5455 | 1.4219 | | |
| STO | infinite | 1.0424 | | |
| S6 | 6.8870 | 5.0000 | 1.62 | 63.4 |
| S7 | −5.5393 | 0.6259 | 1.95 | 17.9 |
| S8 | −40.0000 | 0.3309 | | |
| S9 | 16.7907 | 1.9926 | 1.59 | 61.2 |
| S10 | −31.5301 | 0.5000 | | |
| S11 | infinite | 0.5500 | 1.52 | 64.2 |
| S12 | infinite | 0.5500 | 1.52 | 64.2 |
| S13 | infinite | 2.0965 | | |
| S14 | infinite | 0.5000 | 1.52 | 64.2 |
| S15 | infinite | 0.1250 | | |
| | | / | | |

TABLE 8

| surface | | | | | | | | |
|---|---|---|---|---|---|---|---|---|
| number | k | A4 | A6 | A8 | A10 | A12 | A14 | A16 |
| S1 | −0.3202 | −4.7659E−03 | 2.0459E−05 | 4.8900E−06 | 1.5613E−07 | −3.5478E−08 | 1.4747E−09 | −1.9523E−11 |
| S2 | −0.7528 | −1.0038E−02 | 9.3324E−05 | −3.9764E−05 | 1.8680E−05 | −3.0589E−06 | 2.0729E−07 | −4.2724E−09 |
| S9 | −13.3496 | −6.9374E−04 | −3.0025E−04 | 1.5070E−04 | −3.7324E−05 | 4.9037E−06 | −3.1700E−07 | 7.8116E−09 |
| S10 | 90.0684 | 6.3048E−04 | −3.6380E−04 | 8.1387E−05 | −1.1415E−05 | 6.4179E−07 | 3.1153E−08 | −3.2014E−09 |

### Embodiment 5

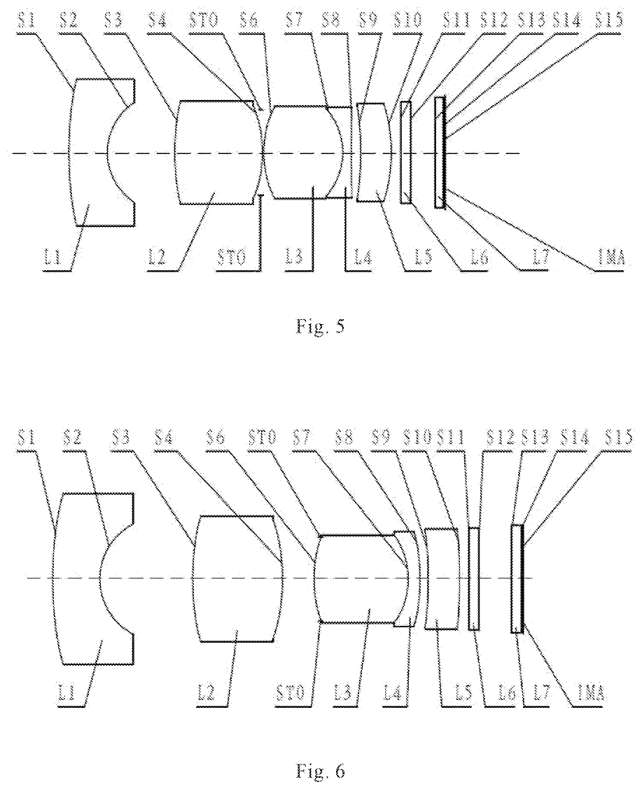

An optical lens assembly according to Embodiment 5 of the present disclosure is described below with reference to FIG. 5. FIG. 5 is a schematic structural diagram of the optical lens assembly according to Embodiment 5 of the present disclosure.

As shown in FIG. 5, the optical lens assembly includes, sequentially along an optical axis from an object side to an image side, a first lens L1, a second lens L2, a third lens L3, a fourth lens L4, and a fifth lens L5.

The first lens L1 is a convex-concave lens having a negative refractive power, an object-side surface S1 of the first lens L1 is a convex surface, and an image-side surface S2 of the first lens L1 is a concave surface. The second lens L2 is a dual-convex lens having a positive refractive power, an object-side surface S3 of the second lens L2 is a convex surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-concave lens having a negative refractive power, an object-side surface S7 of the fourth lens L4 is a concave surface, and an image-side surface S8 of the fourth lens L4 is a concave surface. The fifth lens L5 is a concave-convex lens having a positive refractive power, an object-side surface S9 of the fifth lens L5 is a concave surface, and an image-side surface S10 of the fifth lens L5 is a convex surface. The third lens L3 and the fourth lens L4 may be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position between the second lens L2 and the third lens L3 near the image-side surface S4 of the second lens L2.

Alternatively, the optical lens assembly may further include an optical filter L6 having an object-side surface S11 and an image-side surface 512. The optical filter L6 may be used to correct color deviations. The optical lens assembly may further include a protective glass L7 having an object-side surface S13 and an image-side surface S14. The protective glass L7 may be used to protect an image sensing chip IMA at an imaging plane S15. Light from an object sequentially passes through the surfaces S1-S14 and finally forms an image on the imaging plane S15.

Table 9 shows a radius of curvature R, a thickness d/distance T, a refractive index Nd and an abbe number Vd of each lens of the optical lens assembly in Embodiment 5. Table 10 shows the conic coefficients and the high-order coefficients applicable to the aspheric surfaces in Embodiment 5. Here, the surface type of each aspheric surface may be defined using the formula (1) given in Embodiment 1.

TABLE 9

| | radius of | thickness | | |
|---|---|---|---|---|
| surface | curvature R | d/distance T | refractive | abbe |
| number | (mm) | (mm) | index Nd | number Vd |
| S1 | 4.9136 | 2.0371 | 1.81 | 41.0 |
| S2 | 1.9466 | 3.5682 | | |
| S3 | 12.1594 | 4.6350 | 1.69 | 54.9 |
| S4 | −6.3288 | −0.0885 | | |
| STO | infinite | 0.1657 | | |
| S6 | 5.3725 | 4.1730 | 1.62 | 63.4 |
| S7 | −3.4506 | 0.4623 | 1.85 | 23.8 |
| S8 | 101.6295 | 0.4789 | | |
| S9 | −40.7124 | 1.6195 | 1.59 | 61.2 |
| S10 | −12.5526 | 0.5000 | | |
| S11 | infinite | 0.5500 | 1.52 | 64.2 |
| S12 | infinite | 1.3017 | | |
| S13 | infinite | 0.4000 | 1.52 | 64.2 |
| S14 | infinite | 0.1250 | | |
| S15 | infinite | / | | |

TABLE 10

| surface | | | | | | | | |
|---|---|---|---|---|---|---|---|---|
| number | k | A4 | A6 | A8 | A10 | A12 | A14 | A16 |
| S1 | −0.1611 | −6.2395E−03 | −2.4768E−04 | 1.6274E−05 | 1.8561E−06 | −2.1391E−07 | 7.0974E−09 | −6.2226E−11 |
| S2 | −0.6572 | −1.7072E−02 | −6.5977E−04 | 2.3254E−04 | −3.3659E−05 | 5.7298E−06 | −8.5924E−07 | 4.9370E−08 |
| S9 | −183.0885 | −6.9256E−03 | 1.0074E−04 | 4.1632E−04 | −1.7007E−04 | 3.5291E−05 | −3.3706E−06 | 1.1605E−07 |
| S10 | 6.3188 | −8.6379E−03 | 1.5005E−03 | −3.4694E−04 | 1.1061E−04 | −2.2467E−05 | 2.4914E−06 | −1.0997E−07 |

### Embodiment 6

An optical lens assembly according to Embodiment 6 of the present disclosure is described below with reference to FIG. 6. FIG. 6 is a schematic structural diagram of the optical lens assembly according to Embodiment 6 of the present disclosure.

As shown in FIG. 6, the optical lens assembly includes, sequentially along an optical axis from an object side to an image side, a first lens L1, a second lens L2, a third lens L3, a fourth lens L4, and a fifth lens L5.

The first lens L1 is a convex-concave lens having a negative refractive power, an object-side surface S1 of the first lens L1 is a convex surface, and an image-side surface S2 of the first lens L1 is a concave surface. The second lens L2 is a dual-convex lens having a positive refractive power, an object-side surface S3 of the second lens L2 is a convex surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a concave-convex lens having a negative refractive power, an object-side surface S7 of the fourth lens L4 is a concave surface, and an image-side surface S8 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The third lens L3 and the fourth lens L4 may be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position between the second lens L2 and the third lens L3 near the image-side surface S6 of the third lens L3.

Alternatively, the optical lens assembly may further include an optical filter L6 having an object-side surface S11 and an image-side surface S12. The optical filter L6 may be used to correct color deviations. The optical lens assembly may further include a protective glass L7 having an object-side surface S13 and an image-side surface S14. The protective glass L7 may be used to protect an image sensing chip IMA at an imaging plane S15. Light from an object sequentially passes through the surfaces S1-S14 and finally forms an image on the imaging plane S15.

Table 11 shows a radius of curvature R, a thickness d/distance T, a refractive index Nd and an abbe number Vd of each lens of the optical lens assembly in Embodiment 6. Table 12 shows the conic coefficients and the high-order coefficients applicable to the aspheric surfaces in Embodiment 6. Here, the surface type of each aspheric surface may be defined using the formula (1) given in Embodiment 1.

TABLE 11

| | radius of | thickness | | |
|---|---|---|---|---|
| surface | curvature R | d/distance T | refractive | abbe |
| number | (mm) | (mm) | index Nd | number Vd |
| S1 | 5.9556 | 2.5000 | 1.81 | 41.0 |
| S2 | 2.0759 | 4.9345 | | |
| S3 | 13.1402 | 4.7640 | 1.76 | 52.3 |
| S4 | −10.0689 | 2.0225 | | |
| STO | infinite | −0.3409 | | |
| S6 | 6.5358 | 5.0000 | 1.62 | 63.4 |
| S7 | −3.9776 | 0.6259 | 1.95 | 17.9 |
| S8 | −9.9259 | 0.4414 | | |
| S9 | −37.4756 | 1.6623 | 1.59 | 61.2 |
| S10 | −110.8215 | 0.5000 | | |
| S11 | infinite | 0.5500 | 1.52 | 64.2 |
| S12 | infinite | 1.7163 | | |
| S13 | infinite | 0.5000 | 1.52 | 64.2 |
| S14 | infinite | 0.1250 | | |
| S15 | infinite | / | | |

TABLE 12

| surface | | | | | | | | |
|---|---|---|---|---|---|---|---|---|
| number | k | A4 | A6 | A8 | A10 | A12 | A14 | A16 |
| S1 | −0.4218 | −3.4162E−03 | −9.3008E−05 | 7.5750E−06 | 5.7828E−08 | −1.8739E−08 | 6.2019E−10 | −6.5103E−12 |
| S2 | −0.7393 | −9.6575E−03 | −3.1420E−04 | 1.0261E−04 | −1.0378E−05 | 6.9055E−07 | −4.1267E−08 | 1.5893E−09 |
| S9 | 200.0000 | −3.0797E−03 | 1.2979E−04 | 1.7419E−04 | −6.6310E−05 | 1.1734E−05 | −8.9539E−07 | 2.3950E−08 |
| S10 | −200.0000 | −5.0697E−03 | 1.2603E−03 | −5.6582E−04 | 2.0833E−04 | −4.3621E−05 | 4.7215E−06 | −2.0398E−07 |

### Embodiment 7

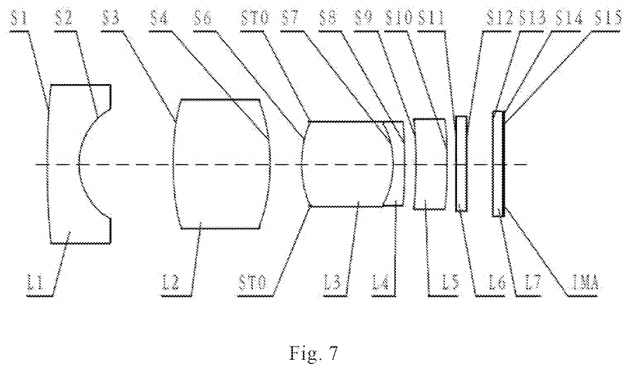

An optical lens assembly according to Embodiment 7 of the present disclosure is described below with reference to FIG. 7. FIG. 7 is a schematic structural diagram of the optical lens assembly according to Embodiment 7 of the present disclosure.

As shown in FIG. 7, the optical lens assembly includes, sequentially along an optical axis from an object side to an image side, a first lens L1, a second lens L2, a third lens L3, a fourth lens L4, and a fifth lens L5.

The first lens L1 is a convex-concave lens having a negative refractive power, an object-side surface S1 of the first lens L1 is a convex surface, and an image-side surface S2 of the first lens L1 is a concave surface. The second lens L2 is a dual-convex lens having a positive refractive power, an object-side surface S3 of the second lens L2 is a convex surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a concave-convex lens having a negative refractive power, an object-side surface S7 of the fourth lens L4 is a concave surface, and an image-side surface S8 of the fourth lens L4 is a convex surface. The fifth lens L5 is a concave-convex lens having a positive refractive power, an object-side surface S9 of the fifth lens L5 is a concave surface, and an image-side surface S10 of the fifth lens L5 is a convex surface. The third lens L3 and the fourth lens L4 may be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position between the second lens L2 and the third lens L3 near the image-side surface S6 of the third lens L3.

Alternatively, the optical lens assembly may further include an optical filter L6 having an object-side surface S11 and an image-side surface S12. The optical filter L6 may be used to correct color deviations. The optical lens assembly may further include a protective glass L7 having an object-side surface S13 and an image-side surface S14. The protective glass L7 may be used to protect an image sensing chip IMA at an imaging plane S15. Light from an object sequentially passes through the surfaces S1-S14 and finally forms an image on the imaging plane S15.

Table 13 shows a radius of curvature R, a thickness d/distance T, a refractive index Nd and an abbe number Vd of each lens of the optical lens assembly in Embodiment 7. Table 14 shows the conic coefficients and the high-order coefficients applicable to the aspheric surfaces in Embodiment 7. Here, the surface type of each aspheric surface may be defined using the formula (1) given in Embodiment 1.

TABLE 13

| | radius of | thickness | | |
|---|---|---|---|---|
| surface | curvature R | d/distance T | refractive | abbe |
| number | (mm) | (mm) | index Nd | number Vd |
| S1 | 6.8661 | 1.7330 | 1.81 | 41.0 |
| S2 | 2.1934 | 5.1461 | | |
| S3 | 13.9826 | 5.3000 | 1.76 | 52.3 |
| S4 | −10.0476 | 2.1977 | | |
| STO | infinite | −0.4676 | | |
| S6 | 5.6248 | 5.0000 | 1.62 | 63.4 |
| S7 | −4.6998 | 0.6259 | 1.95 | 17.9 |
| S8 | −32.1906 | 0.6232 | | |
| S9 | −66.6667 | 1.7072 | 1.59 | 61.2 |
| S10 | −26.8312 | 0.5000 | | |
| S11 | infinite | 0.5500 | 1.52 | 64.2 |
| S12 | infinite | 1.4618 | | |
| S13 | infinite | 0.5000 | 1.52 | 64.2 |
| S14 | infinite | 0.1250 | | |
| S15 | infinite | / | | |

TABLE 14

| surface | | | | | | | | |
|---|---|---|---|---|---|---|---|---|
| number | k | A4 | A6 | A8 | A10 | A12 | A14 | A16 |
| S1 | −0.2831 | −6.7547E−03 | 1.0687E−04 | 2.2035E−05 | −2.0701E−06 | 8.2398E−08 | −1.5537E−09 | 1.0949E−11 |
| S2 | −0.7255 | −1.3686E−02 | 6.0441E−04 | −5.4954E−06 | 3.8996E−06 | −1.0849E−06 | 9.0555E−08 | −2.2985E−09 |
| S9 | −8.7255 | −3.8469E−03 | −1.6562E−04 | 3.2623E−04 | −1.0928E−04 | 1.9371E−05 | −1.6646E−06 | 5.3445E−08 |
| S10 | −32.2687 | −3.7633E−03 | 6.2982E−04 | −1.2945E−04 | 6.9669E−05 | −1.7520E−05 | 2.1078E−06 | −9.5660E−08 |

In summary, Embodiments 1-7 respectively satisfy the relationships shown in the following Table 15. In Table 15, the units of TTL, F, BFL, D, H, F, F2, F3, F4, F5, R1, R2, R3, R4, R6, R7, T12, T23 and T45 are millimeters (mm), and the unit of FOV is degrees (°).

TABLE 15

| conditional | | | | | | | |
|---|---|---|---|---|---|---|---|
| expression/ | embodiment | embodiment | embodiment | embodiment | embodiment | embodiment | embodiment |
| embodiment | 1 | 2 | 3 | 4 | 5 | 6 | 7 |
| TTL | 23.0174 | 22.7129 | 24.0095 | 24.9958 | 19.9279 | 25.0009 | 25.0022 |
| F | 5.0753 | 6.0283 | 6.2695 | 3.8491 | 4.3238 | 4.2881 | 3.8282 |
| BFL | 2.9481 | 3.8815 | 3.9027 | 3.7715 | 2.8767 | 3.3913 | 3.1368 |
| D | 7.9531 | 9.5325 | 9.5549 | 8.4648 | 7.7567 | 9.0329 | 8.6777 |
| H | 4.9427 | 7.4438 | 7.3412 | 5.6488 | 5.4827 | 5.5786 | 5.6818 |
| FOV | 100 | 100 | 100 | 100 | 100 | 100 | 100 |
| F1 | −8.8001 | −8.2965 | −9.6133 | −4.6065 | −5.7200 | −5.5036 | −4.7465 |
| F2 | 8.8788 | 9.2603 | 9.5298 | 8.1726 | 6.6842 | 8.2464 | 8.5190 |
| F3 | 5.2577 | −14.5279 | −11.3555 | 5.8503 | 4.1360 | 4.8735 | 5.0670 |
| F4 | −4.7833 | 5.5146 | 6.9817 | −6.7697 | −3.8951 | −7.3022 | −5.8075 |
| F5 | 12.4218 | −110.3081 | 22.2743 | 18.8132 | 30.0428 | −96.5531 | 74.7329 |
| TTL/F | 4.535 | 3.768 | 3.830 | 6.494 | 4.609 | 5.830 | 6.531 |
| BFL/TTL | 0.128 | 0.171 | 0.163 | 0.151 | 0.144 | 0.136 | 0.125 |
| D/H/FOV | 0.016 | 0.013 | 0.013 | 0.015 | 0.014 | 0.016 | 0.015 |
| \|F1/F\| | 1.734 | 1.376 | 1.533 | 1.197 | 1.323 | 1.283 | 1.240 |
| \|F1/F2\| | 0.991 | 0.896 | 1.009 | 0.564 | 0.856 | 0.667 | 0.557 |
| \|F3/F4\| | 1.099 | 2.634 | 1.626 | 0.864 | 1.062 | 0.667 | 0.872 |
| \|R1/R2\| | 2.035 | 2.070 | 2.298 | 3.125 | 2.524 | 2.869 | 3.130 |
| \|R3/R4\| | 1.629 | 3.300 | 1.000 | 2.128 | 1.921 | 1.305 | 1.392 |
| \|R6/R7\| | 1.000 | 1.590 | 1.986 | 1.243 | 1.557 | 1.643 | 1.197 |
| T12/TTL | 0.242 | 0.194 | 0.203 | 0.200 | 0.179 | 0.197 | 0.206 |
| T23/TTL | 0.066 | 0.097 | 0.065 | 0.099 | 0.004 | 0.067 | 0.069 |
| F2/F | 1.749 | 1.536 | 1.520 | 2.123 | 1.546 | 1.923 | 2.225 |
| F3/F | 1.036 | −2.410 | −1.811 | 1.520 | 0.957 | 1.137 | 1.324 |
| F4/F | −0.942 | 0.915 | 1.114 | −1.759 | −0.901 | −1.703 | −1.517 |
| F5/F | 2.447 | −18.298 | 3.553 | 4.888 | 6.948 | −22.516 | 19.522 |
| T45/TTL | 0.021 | 0.061 | 0.064 | 0.013 | 0.024 | 0.018 | 0.025 |
| (FOV × F)/H | 102.682 | 80.985 | 85.401 | 68.141 | 78.863 | 76.867 | 67.378 |
| \|Vd3 − Vd4\| | 39.60 | 62.70 | 62.70 | 45.50 | 39.60 | 45.50 | 45.50 |
| \|(1/(F4 × | 0.029 | 0.009 | 0.018 | 0.021 | 0.030 | 0.019 | 0.025 |
| Vd4) + 1/(F3 × | | | | | | | |
| Vd3)) × F\| | | | | | | | |

The present disclosure further provides an electronic device, which may include the optical lens assembly according to the above embodiments of the present disclosure and an imaging element used to convert an optical image formed by the optical lens assembly into an electrical signal. The electronic device may be an independent electronic device such as a detection distance camera, or may be an imaging module integrated into, for example, a detection distance device. In addition, the electronic device may be an independent imaging device such as a vehicle-mounted camera, or may be an imaging module integrated into, for example, a driving assistance system.

The foregoing is only a description for the preferred embodiments of the present disclosure and the applied technical principles. It should be appreciated by those skilled in the art that the scope of the present disclosure is not limited to the technical solution formed by the particular combination of the above technical features. The scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical lens assembly, comprising, sequentially along an optical axis from an object side to an image side:
a first lens, having a negative refractive power, an object-side surface of the first lens being a convex surface, and an image-side surface of the first lens being a concave surface;
a second lens, having a positive refractive power, an object-side surface of the second lens being a convex surface, and an image-side surface of the second lens being a convex surface;
a third lens, having a refractive power;
a fourth lens, having a refractive power; and
a fifth lens, having a refractive power.

2. The optical lens assembly according to claim 1, wherein the third lens has a positive refractive power, an object-side surface of the third lens is a convex surface, and an image-side surface of the third lens is a convex surface; or the third lens has a negative refractive power, an object-side surface of the third lens is a convex surface, and an image-side surface of the third lens is a concave surface.

3. The optical lens assembly according to claim 1, wherein the fourth lens has a positive refractive power, an object-side surface of the fourth lens is a convex surface, and an image-side surface of the fourth lens is a convex surface; or the fourth lens has a negative refractive power, an object-side surface of the fourth lens is a concave surface, and an image-side surface of the fourth lens is a concave surface or a convex surface.

4. The optical lens assembly according to claim 1, wherein the fifth lens has a positive refractive power, an object-side surface of the fifth lens is a convex surface or a concave surface, and an image-side surface of the fifth lens is a convex surface; or the fifth lens has a positive refractive power, an object-side surface of the fifth lens is a convex surface, and an image-side surface of the fifth lens is a concave surface; or the fifth lens has a negative refractive power, an object-side surface of the fifth lens is a concave surface, and an image-side surface of the fifth lens is a convex surface.

5. The optical lens assembly according to claim 1, wherein the third lens and the fourth lens are cemented to form a cemented lens; or the first lens and the fifth lens both have an aspheric surface.

6. The optical lens assembly according to claim 1, wherein a distance TTL from a center of the object-side surface of the first lens to an imaging plane of the optical lens assembly on the optical axis and a total effective focal length F of the optical lens assembly satisfy: TTL/F≤8.

7. The optical lens assembly according to claim 1, wherein a distance BFL from the image-side surface of the fifth lens to an imaging plane of the optical lens assembly on the optical axis and a distance TTL from a center of the object-side surface of the first lens to the imaging plane of the optical lens assembly on the optical axis satisfy: 0.07≤BFL/TTL≤0.35.

8. The optical lens assembly according to claim 1, wherein a maximal field-of-view FOV of the optical lens assembly, a maximal aperture D of the object-side surface of the first lens corresponding to the maximal field-of-view of the optical lens assembly and an image height H corresponding to the maximal field-of-view of the optical lens assembly satisfy: D/H/FOV≤0.025.

9. The optical lens assembly according to claim 1, wherein an effective focal length F1 of the first lens and a total effective focal length F of the optical lens assembly satisfy: 0.5≤|F1/F|≤3.

10. The optical lens assembly according to claim 1, wherein an effective focal length F1 of the first lens and an effective focal length F2 of the second lens satisfy: 0.3≤|F1/F2|≤3.5.

11. The optical lens assembly according to claim 1, wherein an effective focal length F3 of the third lens and an effective focal length F4 of the fourth lens satisfy: 0.3≤|F3/F4|≤3.5.

12. The optical lens assembly according to claim 1, wherein a radius of curvature R1 of the object-side surface of the first lens and a radius of curvature R2 of the image-side surface of the first lens satisfy: R1/R2|≤5; or a radius of curvature R6 of the object-side surface of the third lens and a radius of curvature R7 of the image-side surface of the third lens satisfy: 0.5≤|R6/R7|≤5.

13. The optical lens assembly according to claim 1, wherein a radius of curvature R3 of the object-side surface of the second lens and a radius of curvature R4 of the image-side surface of the second lens satisfy: 0.5≤|R3/R4|≤5.

14. The optical lens assembly according to claim 1, wherein a spacing distance T12 from a center of the image-side surface of the first lens to a center of the object-side surface of the second lens on the optical axis and a distance TTL from a center of the object-side surface of the first lens to an imaging plane of the optical lens assembly on the optical axis satisfy: 0.1≤T12/TTL≤0.6; or a spacing distance T45 from a center of the image-side surface of the fourth lens to a center of the object-side surface of the fifth lens on the optical axis and a distance TTL from a center of the object-side surface of the first lens to an imaging plane of the optical lens assembly on the optical axis satisfy: 0.008≤T45/TTL≤0.3.

15. The optical lens assembly according to claim 1, wherein a spacing distance T23 from a center of the image-side surface of the second lens to a center of the object-side surface of the third lens on the optical axis and a distance TTL from a center of the object-side surface of the first lens to an imaging plane of the optical lens assembly on the optical axis satisfy: T23/TTL≤0.25.

16. The optical lens assembly according to claim 1, wherein a maximal field-of-view FOV of the optical lens assembly, a total effective focal length F of the optical lens assembly and an image height H corresponding to the maximal field-of-view of the optical lens assembly satisfy: (FOV×F)/H≥57°.

17. The optical lens assembly according to claim 1, wherein an abbe number Vd3 of the third lens and an abbe number Vd4 of the fourth lens satisfy: |Vd3−Vd4|≥20.

18. The optical lens assembly according to claim 1, wherein an effective focal length F3 of the third lens, an effective focal length F4 of the fourth lens, an abbe number Vd3 of the third lens, an abbe number Vd4 of the fourth lens and a total effective focal length F of the optical lens assembly satisfy:

|(1/(F4×Vd4)+1/(F3×Vd3))×F|≤0.15.

19. An optical lens assembly, comprising, sequentially along an optical axis from an object side to an image side:
a first lens, having a negative refractive power;
a second lens, having a positive refractive power;
a third lens, having a refractive power;
a fourth lens, having a refractive power;
a fifth lens, having a refractive power; and
a maximal field-of-view FOV of the optical lens assembly, a total effective focal length F of the optical lens assembly and an image height H corresponding to the maximal field-of-view of the optical lens assembly satisfy: (FOV×F)/H≥57°.

20. An electronic device, comprising the optical lens assembly and an imaging element used to convert an optical image formed by the optical lens assembly into an electrical signal;
Wherein the optical lens assembly comprises, sequentially along an optical axis from an object side to an image side:
a first lens, having a negative refractive power, an object-side surface of the first lens being a convex surface, and an image-side surface of the first lens being a concave surface;
a second lens, having a positive refractive power, an object-side surface of the second lens being a convex surface, and an image-side surface of the second lens being a convex surface;
a third lens, having a refractive power;
a fourth lens, having a refractive power; and
a fifth lens, having a refractive power.
